(19) United States
(12) Patent Application Publication
(10) Pub. No.: US 2007/0244981 A1
(43) Pub. Date: Oct. 18, 2007

(54) Disseminating information about security threats

(76) Inventors: Matthew Scott Malden, San Francisco, CA (US); Daniel Edward Israel, San Francisco, CA (US); Robert Brent Pinkerton, San Francisco, CA (US); Arun Abichandani, Alameda, CA (US); Hang Yee Wong, Oakland, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 10/244,137

(22) Filed: Sep. 12, 2002

Related U.S. Application Data
(60) Provisional application No. 60/392,719, filed on Jun. 27, 2002.

(51) Int. Cl. G06F 15/16

(52) U.S. Cl. 709/217

(57) ABSTRACT

A facility for disseminating homeland security information is described. The facility identifies a mobile device used by an addressee of a message containing homeland security information, and transmits this message to the identified mobile device.

### CROSS-REFERENCE TO RELATED APPLICATIONS

This application claims the benefit of provisional U.S. Patent Application No. 60/392,719, filed Jun. 27, 2002, which is hereby incorporated by reference in its entirety.

### TECHNICAL FIELD

The present invention is directed to the field of data distribution.

### BACKGROUND

As the security of governments, businesses, other organizations, and individuals is increasingly threatened by various individuals and groups, including terrorists, it has become increasingly important to be able to timely and effectively deliver information useful in preventing future threats, responding to unfolding threats, and investigating those who may have contributed to past threats or may contribute to future threats.

Unfortunately, conventional procedures for delivering such critical information are highly reliant on relatively ineffective, labor-intensive manual processes, such as in-person meetings, person-to-person telephone calls, and paper memoranda. Such manual procedures are highly subject to failure, especially in time-critical situations where particular information must be delivered to particular groups of people.

While some of these processes have been automated to a limited extent, the automated versions are typically embodied in limited and out-of-date custom software running on legacy hardware. In order to obtain useful information from such an automated system, users may have to take the initiative to generate and submit one or more arcane queries, and interpret cryptic query results. Often such action must be taken at computer terminals whose location is fixed in an investigative or law enforcement facility, making such systems difficult or impossible to use by someone currently in a different location.

Accordingly, techniques for timely and effectively distributing information useful in contending with security threats would have significant utility.

### BRIEF DESCRIPTION OF THE DRAWINGS

FIG. 1 shows a multi-layered system architecture within which the described techniques can be implemented.

FIG. 2 shows a block diagram of one embodiment of a system configuration in which the described techniques can be implemented.

FIG. 3 shows a block diagram illustrating a logical representation of a multi-layered architecture within which the described techniques can be implemented.

FIG. 4 illustrates a block diagram of one embodiment of an application framework within which the described techniques can be implemented.

FIG. 5 is a block diagram showing ways in which the facility typically delivers security threat information to individuals.

FIG. 6 is a display diagram showing a sample portal display for the Investigative Agent sample constituency.

FIG. 7 is a display diagram showing a sample portal display for the State Government Call Center Agent sample constituency.

FIG. 8 is a display diagram showing a sample portal display for the Public Health Professional sample constituency.

FIG. 9 is a display diagram showing a sample portal display for the Member of Public sample constituency.

FIG. 10 is a display diagram showing a sample portal display for the Member of Public with Additional Access Privileges sample constituency.

FIG. 11 is a data flow diagram showing a typical process used by the facility to support the biometric screening of individuals designated as terrorism suspects.

### DETAILED DESCRIPTION

I. Introduction

A software facility for timely and effectively distributing information useful in contending with security threats such as acts of terrorism (“the facility”) is described. For example, in some embodiments, the facility delivers information useful in preventing future threats, responding to unfolding threats, and investigating those who may have contributed to past threats or may contribute to future threats. Embodiments of the facility can provide essential, targeted information for dealing with terrorist activities and other security threats to the right individuals and groups, without having to rely on ineffective, labor-intensive legacy manual processes for conveying such information. Embodiments of the facility allow such information to be shared based upon business rules, in some cases between a variety of off-the-shelf and custom software and/or hardware systems.

In some embodiments, the facility enables individuals to receive important, up-to-the-minute security threat information via portable communication devices in locations outside the office, such as locations in which investigations or incident response are taking place. Such information may be provided both synchronously—in response to specific requests from the individual, and asynchronously—based upon a determination by the facility that the information should be provided. This aspect of the facility significantly expands the set of places in and times at which individuals can receive new security threat information, helping these individuals to be better-informed on the whole, and more effective in dealing with security threats. Embodiments of the facility also provide such information to users in their offices or in other fixed locations. The facility allows a number of different agents or other users to share information and jointly work on resolving cases simultaneously, and in real-time. In some embodiments, the facility provides differential levels of access to information by users based upon their identity. In some embodiments, the facility automatically routes and assigns investigative leads and tasks using business rules and workflow processes.

In some embodiments, the facility provides a number of different web-based information access points, or “portals,” for each of a number of different security threat information constituencies. These portals convey different subsets of the available security threat information, based upon the particular needs and trust levels of each constituency. For example, a portal for investigative agents may provide specific sensitive information about ongoing investigations into security threats, while a portal for members of the public may provide information about how to deal with particular health risks. This aspect of the facility helps to provide a rich set of information to each of a number of different constituencies without having to manage the sources of such information separately for each constituency.

In some embodiments, the facility provides a web-based, off-the-shelf application for use by security-tasked government agencies, providing such services as collecting, analyzing, synthesizing, and distributing security threat information. This aspect of the facility helps security agencies to take advantage of the latest commercial software technologies quickly, and at a reasonable cost.

In some embodiments, the application is usable by multiple such agencies to communicate and share information, providing a vehicle for quickly moving important information to the appropriate individuals, even if they are in different organizations.

In some embodiments, the facility provides support for the biometric screening of individuals designated as terrorism suspects. Agents having appropriate authorization may use the facility to select certain individuals identified within the facility for particular treatment when they are identified using biometric screening. For example, biometric screening may be performed by a contractor at airport boarding gates. For each of a number of individuals, authorized agents can use the facility to designate particular treatment of the individual to be undertaken when biometric screening at a boarding gate identifies a passenger as the individual. For example, the facility may be used to designate that certain individuals are to be denied boarding, others are to be detained, and still others are to be unobtrusively reported to have boarded. The facility makes these designations available to the biometric screening contractor, who associates them with biometric profiles usable to identify the individuals during biometric screening. This aspect of the facility assists security agencies in making more effective use of biometric screening operations.

II. System Overview and Overall Architecture

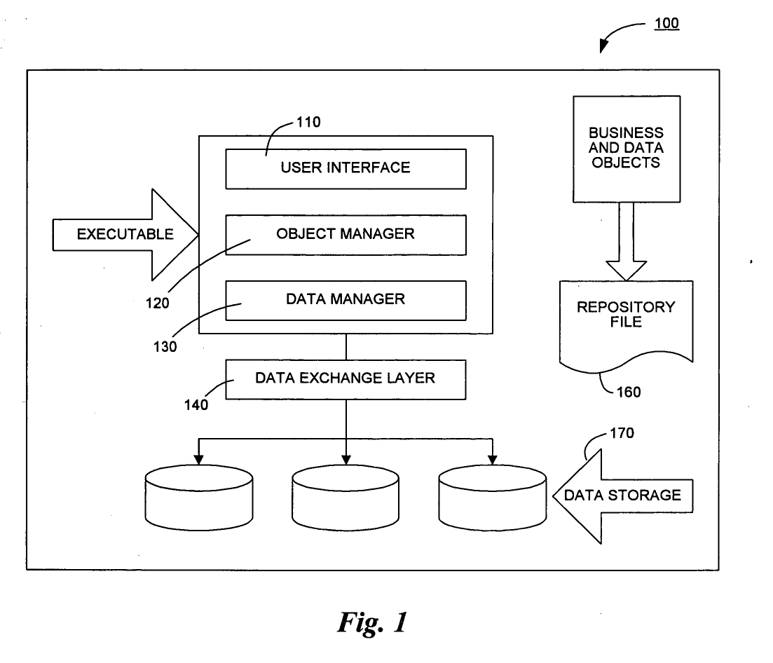

In one embodiment, a computing system with which the facility is integrated can be logically structured as a multi-layered architecture as shown in FIG. 1. In particular, the logical multi-layered architecture as shown in FIG. 1 provides a platform for common services to support various applications. These services may include a user interface layer 110, an object manager layer 120, a data manager layer 130, and a data exchange layer 140.

The user interface layer 110 may provide a variety of high-level GUI elements such as applets, views, charts and reports that are associated with one or more applications. In one embodiment, various types of clients can be supported via the user interface layer 110. These various types of clients may include traditional connected clients, remote clients, thin clients over an intranet, Java thin clients, ActiveX clients, HTML clients over the Internet, etc.

The object manager layer 120 may be designed to manage one or more sets of business rules or business concepts associated with one or more applications and to provide the interface between the user interface layer 110 and the data manager layer 130. In one embodiment, the business rules or concepts can be represented as business (or “business process”) objects. The business objects may also be designed as configurable software representations of various business rules or concepts, such as accounts, contacts, opportunities, service requests, solutions, suspects, terrorist groups, diseases, medications, and cases, etc.

The data manager layer 130 may be designed to maintain logical views of the underlying data and to allow the object manager to function independently of underlying data structures or tables in which data are stored. In one embodiment, the data manager 130 may also provide certain database query functions such as generation of structure query language (SQL) in real-time to access the data. In one embodiment, the data manager 130 is designed to operate on object definitions in a repository file 160 that define the database schema. The data storage services 170 provide the data storage for the data model associated with one or more applications.

The data exchange layer 140 may be designed to handle the interactions with one or more specific target databases and to provide the interface between the data manager layer 130 and the underlying data sources.

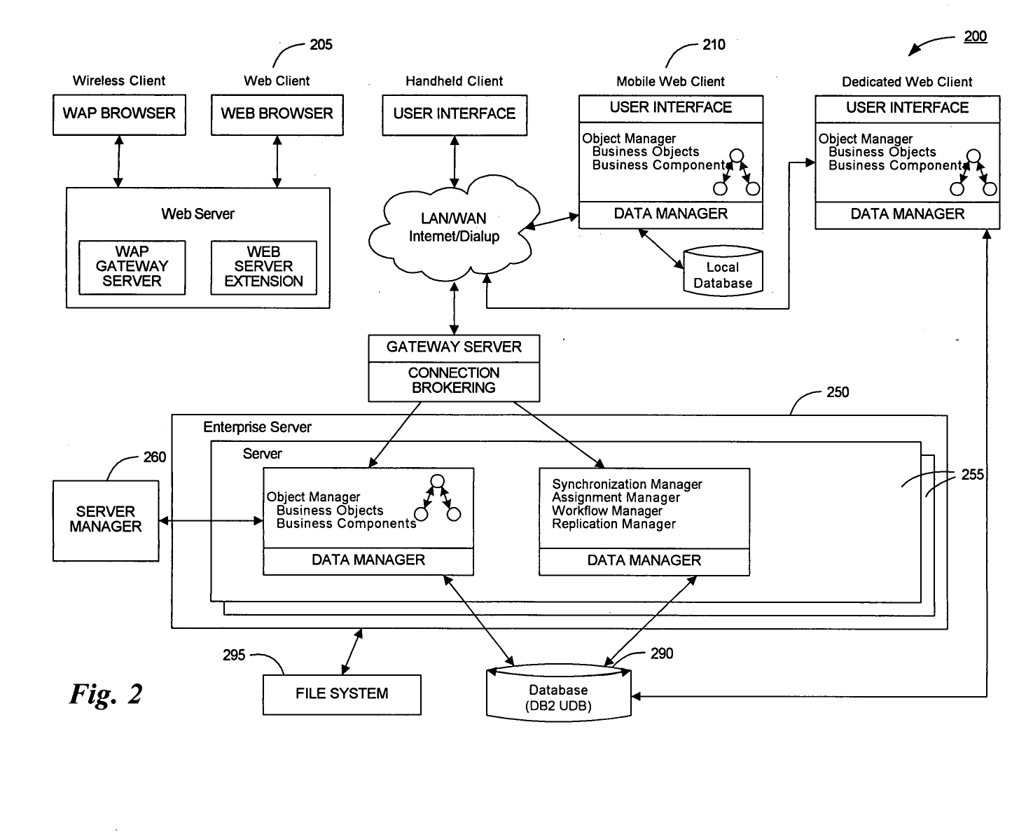

FIG. 2 shows a block diagram of one embodiment of a computing system configuration in which the facility can operate. In particular, the illustrated multi-layered architecture allows one or more software layers to reside on different machines. For example, the user interface, the object manager, and the data manager may all reside on the dedicated Web clients. For other types of clients such as the wireless clients, the object manager and data manager may reside on a system server. It should be appreciated and understood by one skilled in the art that the system configuration shown in FIG. 2 is for illustrative and explanative purposes, and may vary depending upon the particular implementations and applications of the described techniques.

In one embodiment, the system environment illustrated in FIG. 2 may include more than one database 290, and one or more subsets of the database can be created or replicated by a replication manager. In addition, mobile Web clients can have additional remote databases with respect to the database 290 (also referred to as local databases with respect to those clients). In one embodiment, unless the remote/local databases associated with the mobile Web clients are defined as read-only databases, these mobile Web clients can create and update data locally that will be ultimately propagated up to the primary database when each mobile Web client synchronizes with the system server.

In one embodiment, the database 290 is designed to store various types of data including predefined data schema (e.g., table objects, index objects, etc.), repository objects (e.g., business objects and components, view definitions and visibility rules, etc.), and users' and customers' data. Dedicated Web clients and server components, including those that operate in conjunction with the other types of clients, may connect directly to the database 290 and make changes in real-time. In addition, mobile Web clients may download a subset of the server's data to use locally, and periodically synchronize with the server database through the system server to update both the local and the server database.

In some embodiments, various tables included in the database 290 may be logically organized into the following types: data tables, interface tables, and repository tables, etc. In addition, data tables may be used to store user business data, administrative data, seed data, and transaction data, etc. In one embodiment, these data tables may be populated and updated through the various applications and processes. Data tables may also include the base tables and the intersection tables, etc. In one embodiment, base tables may contain columns that are defined and used by the various applications. In one embodiment, the base tables are designed to provide the columns for a business component specified in the table property of that business component. In one embodiment, intersection tables are tables that are used to implement a many-to-many relationship between two business components. They may also hold intersection data columns, which store information pertaining to each association. In one embodiment, intersection tables provide the data structures for association applets.

In one embodiment, interface tables are used to denormalize a group of base tables into a single table that external programs can interface to. In one embodiment, they may be used as a staging area for exporting and importing of data.

In one embodiment, repository tables contain the object definitions that specify one or more applications regarding:
the client application configuration;
the mapping used for importing and exporting data; and
rules for transferring data to mobile clients.

In one embodiment, the file system 295 is a network-accessible directory that can be located on an application server. In one embodiment, the file system 295 stores the physical files created by various applications, such as files created by third-party text editors, and other data that is not stored in the database 290. In one embodiment, physical files stored in the file system 295 can be compressed and stored under various naming conventions. In one embodiment, dedicated Web clients can read and write files directly to and from the file system 295. In one embodiment, mobile Web clients can have a local file system, which they synchronize with the server-based file system 290 periodically. In one embodiment, other types of client such as the wireless clients and the Web clients can access the file system 290 via the system server.

In one embodiment, the enterprise server 250 is a logical grouping of the system servers 255 that share a common table owner or a database, point to a common gateway server, and can be administered as a group using server manager 260. In one embodiment, the connection to the gateway server can be established via TCP/IP. In one embodiment, the enterprise server 250 can be scaled effectively by deploying multiple system servers 255 in the enterprise server 250, thus providing a high degree of scalability in the middle tier of applications.

In one embodiment, the server 255 runs one or multiple server programs. It handles the incoming processing requests and monitors the state of all processes on the server. In one embodiment, server programs are designed and configured to perform one or more specific functions or jobs including importing and exporting data, configuring the database, executing workflow and process automation, processing to support mobile Web clients for data synchronization and replication, and enforcing business rules, etc. In one embodiment, the server 255 can be an NT Service (under Windows NT operating system) or a daemon (e.g., a background shell process) under UNIX operating system. In one embodiment, the server 255 supports both multi-process and multi-threaded components and can operate components in batch, service, and interactive modes.

In one embodiment, the server manager 260 is configured as a utility that allows common control, administration and monitoring across disparate programs for the servers 255 and the enterprise server 250. In one embodiment, the server manager 260 can be used to perform the following tasks: start, stop, pause, and resume servers 255, components, and tasks; monitor status and collect statistics for multiple tasks, components, and servers within an enterprise server; and configure the enterprise server, individual servers, individual components, and tasks, etc.

In one embodiment, the gateway server can be configured as a logical entity that serves as a single entry point for accessing servers. In one embodiment, it can be used to provide enhanced scalability, load balancing and high availability across the enterprise server. In one embodiment, the gateway server may include a name server and a connection brokering component. In one embodiment, the name server is configured to keep track of the parameters associated with the servers. For example, the availability and connectivity information associated with the servers can be stored in the name server. The various components in the system can query the name server for various information regarding the servers' availability and connectivity. In a Windows NT environment, the name server can be run as a NT service. In a UNIX environment, the name server can run as a daemon process. In one embodiment, the connection brokering component is used to perform load balancing functions such as directing client connection requests to an appropriate server (e.g., the least-busy server).

In one embodiment, as illustrated in FIG. 2, the various types of clients that can be supported by the system may include the following clients: dedicated Web clients, mobile Web clients, Web clients, wireless clients, and handheld clients, etc.

In one embodiment, dedicated Web clients (also called connected clients) are connected directly to a database server for data access via a LAN or WAN connection. In one embodiment, these connected or dedicated Web clients do not store data locally. These dedicated Web clients can also access the file system directly. In one embodiment, the user interface, the object manager, and the data manager layers of the multi-layered architecture reside on the dedicated Web client.

In one embodiment, the mobile Web clients are designed and configured for local data access and thus can have their own local database and/or local file system. In one embodiment, mobile Web clients can interact with other components within the system via the gateway server. Through synchronization, the modifications from the local database and the server database can be exchanged.

In one embodiment, a Web client runs in a standard browser format from the client's machine. In one embodiment, the Web client can connect to a system server 255 through a Web server. In one embodiment, the system server 255 is designed and configured to execute business logic and access data from the database 290 and file system 295. In one embodiment, the Web client described herein is designed and configured to operate in an interactive mode. In one embodiment, the interactive Web client framework as described herein utilizes dynamically created objects implemented in JavaScript on the browser side that correspond to objects on the server side. In one embodiment, these dynamically created objects on the browser side may include the current view and its corresponding applets, the current business object and the corresponding business components, etc.

In one embodiment, wireless clients are essentially thin clients enabled on wireless devices. The wireless clients can use a wireless application protocol (WAP)-based user interface to communicate and exchange information/data with the system server.

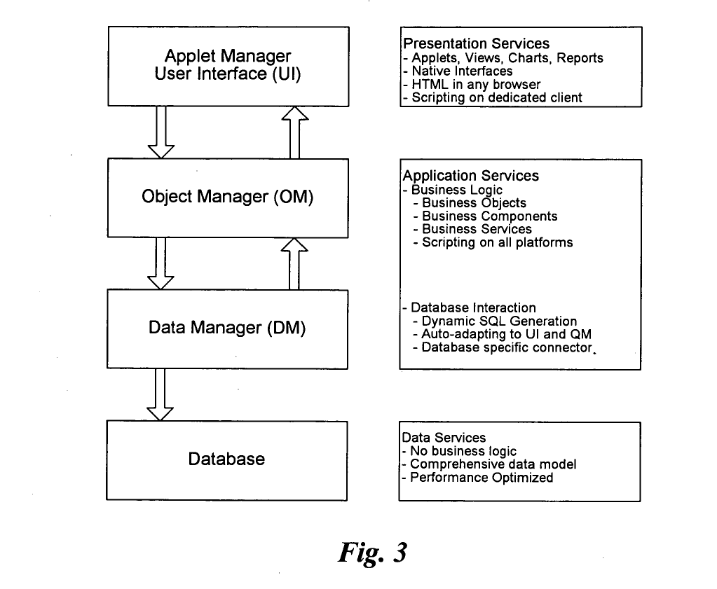

FIG. 3 shows a block diagram illustrating another logical representation of a multi-layered architecture. Again, the multi-layered architecture as illustrated in FIG. 3 provides the configured platform for various common services designed to support the various applications. In one embodiment, these various services may include presentation services which correspond to an applet manager and user interface layer, application services which correspond to an object manager (OM) layer and a data manager (DM) layer, and data services which correspond to a database layer.

In one embodiment, the presentation services may be designed and configured to support various types of clients and may provide them with user interface applets, views, charts, and reports, etc. As described above, a large variety of clients may be supported including wireless clients, handheld clients, Web clients, mobile Web clients, and dedicated (connected) clients, etc.

In one embodiment, the application services may include business logic services and database interaction services. In one embodiment, business logic services provide the class and behaviors of business objects and business components. In one embodiment, database interaction services may be designed and configured to take the user interface (UI) request for data from a business component and generate the database commands (e.g., SQL queries) necessary to satisfy the request. For example, the data interaction services may be used to translate a call for data into DBMS-specific SQL statements.

In one embodiment, data storage services may be designed and configured to provide the data storage for the underlying data model which serves as the basis of the various applications. For example, the data model may be designed and configured to support various software products and applications including call center, sales, services, and marketing, etc., as well as various industry vertical products and applications such as eFinance, eInsurance, eCommunications, and eHealthcare, etc.

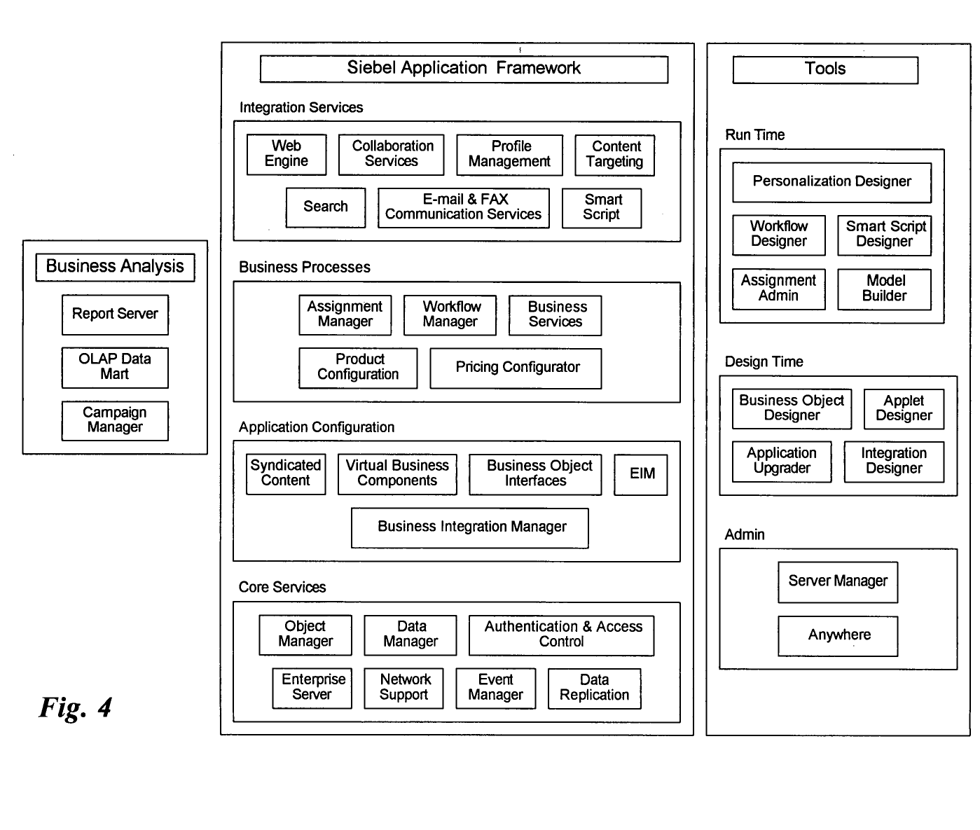

FIG. 4 illustrates a block diagram of one embodiment of an application framework. As illustrated in FIG. 4, the application framework may include various logical groupings of various types of services and various types of tools that can be used to design and configure particular applications based on business needs and environments.

In one embodiment, the core services are designed and configured to provide the framework in which the applications execute. In one embodiment, the core services may include the following:
the enterprise server, which is the middle-tier application server;
the networks that link all of these pieces together;
facilities like event manager and data replication, which allow sharing data between multiple installations of various applications as well as between the various applications and other external applications; and
the authentication and access control, the security facilities.

In one embodiment, application integration services may be designed and configured to allow the various applications built in accordance with this framework to communicate with the external world. In one embodiment, the various types of services in this logical grouping may be designed and configured to provide for real-time, near-real-time, and batch integration with external applications. For example, these integration services may be used to enable communications between external applications and the internal applications using available methods, technologies, and software products. In one embodiment, application integration services allow the systems or applications to share and replicate data with other external enterprise applications. Accordingly, these services allow a particular application or system to be both a client requesting information and a server having information requested from it.

In one embodiment, business processes services are designed and configured to allow the client to automate business processes through the application. In one embodiment, these various business process services may include the following:
assignment of investigative leads and tasks through Assignment Manager;
enforcement of business practices through Workflow Manager;
reuse of custom business logic through Business Services.

In one embodiment, creation of these business processes can be done through Run-Time tools such as Personalization Designer, Workflow Designer, SmartScript Designer, Assignment Administration Views, the Model Builder, etc.

In one embodiment, integration services may be designed and configured to provide the client with user interface and thin client support. In one embodiment, these may include capabilities for building and maintaining Web-based applications, providing Web support facilities such as user Profile Management, Collaboration Services and Email and Fax services, as well as advanced Smart Scripting, etc.

In one embodiment, design time tools may be designed and configured to provide the services to customize, design, provide integration points, and maintain the application. These various tools provide one common place to define the application.

In one embodiment, admin services are designed and configured to provide one place to monitor and administer the application environment. In one embodiment, these services allow the user to administer the application either through a graphic user interface (GUI) or from a command line.

III. Examples And Additional Details

For illustrative purposes, some embodiments of the software facility are described below in which specific types of security-related information are provided to various specific types of users in various specific ways. However, those skilled in the art will appreciate that the techniques of the invention can be used in a wide variety of other situations, and that the invention is not limited to use with the illustrated types of notification techniques or with the illustrated types of security-related information or users.

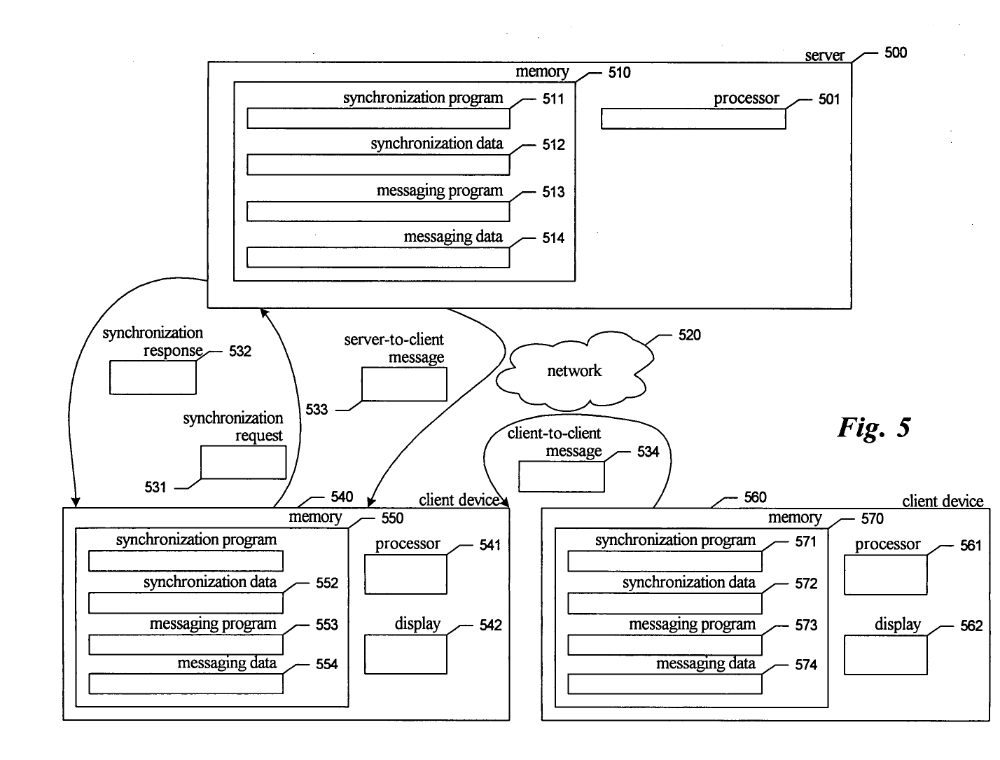

FIG. 5 is a block diagram showing ways in which the facility typically delivers security threat information to individuals. FIG. 5 shows the delivery of security threat information to client device 540 from a server 500 and a second client device 560 via a network 520. The client devices shown may be of a variety of different types, including desktop or laptop general-purpose computer systems, personal digital assistants, wired and wireless telephones, etc.

The network 520 may use a variety of different networking technologies, including wired, guided or line-of-sight optical, or radio frequency networking. Such networking technologies may be used either homogeneously or heterogeneously. In some embodiments, the network includes the public switched telephone network and/or various wireless voice and/or data networks. Network connections between a client and a server or a pair of clients may be fully-persistent, session-based, or intermittent, such as packet-based.

The server 500 typically includes a processor 501 for executing computer programs and a memory 510 for storing programs and data, including data structures. The memory 510 typically contains synchronization data 512 to be synchronized with corresponding synchronization data on various clients using a synchronization program 511. Memory 510 may also, or alternatively, include messaging data 514 to be exchanged with messaging data on the client devices using a messaging program 513. The client devices typically have analogous, though sometimes differently-implemented versions of the components described in conjunction with the server 500. In addition, they typically have a display device 542 on which they can display information to their users, such as security threat information received on behalf of their users.

While computer systems and other devices configured as described above are typically used to support the operation of the facility, those skilled in the art will appreciate that the facility may be implemented using devices of various types and configurations, and having various components.

Security threat information may be delivered to client devices in a variety of ways, including, but not limited to, client-initiated synchronization with a server, and asynchronous messaging from a server or another client. For client-initiated synchronization, client 540 sends server 500 a synchronization request 531 via the network 520. The synchronization request 531 requests that new synchronization data 512 on the server designated for receipt on the client be delivered to the client. The synchronization request may also include new synchronization data 532 on the client designated for receipt on the server. The server replies to the synchronization request with a synchronization response 532 containing new synchronization data 512 on the server designated for the client, including security threat information. When security threat information contained in a synchronization response is received at client 540, the client displays the security threat information on display device 542.

Additional details about implementing client-initiated synchronization is provided in the following patent applications, each of which is hereby incorporated by reference in its entirety: U.S. patent application Ser. No. 09/820,516, entitled “METHOD AND SYSTEM FOR SERVER SYNCHRONIZATION WITH A COMPUTING DEVICE VIA A COMPANION DEVICE,” filed Mar. 28, 2001; U.S. patent application Ser. No. 09/820,509, entitled “METHOD AND SYSTEM FOR DIRECT SERVER SYNCHRONIZATION WITH A COMPUTING DEVICE,” filed Mar. 28, 2001; U.S. patent application Ser. No. 09/976,400, entitled “METHOD AND SYSTEM FOR TRANSFERRING INFORMATION DURING SERVER SYNCHRONIZATION WITH A COMPUTING DEVICE,” filed Oct. 11, 2001; and U.S. patent application Ser. No. 09/992,511, entitled “METHOD AND SYSTEM FOR CLIENT-BASED OPERATIONS IN SERVER SYNCHRONIZATION WITH A COMPUTING DEVICE,” filed on Nov. 5, 2001.

Security threat information may also be delivered to a client via asynchronous messaging, either from a server or from another client. For example, server 500 may send an asynchronous message 533 containing security threat information to client device 540 on its own initiative. The asynchronous message may be an electronic mail message, an instant message, or any of a number of other types of messages or alerts. Similarly, client 560 may send an asynchronous message 534 containing security threat information to client device 540 on its own initiative. In some embodiments, the facility uses one or more other information delivery technologies besides client-initiated synchronization asynchronous messaging to deliver security threat information to client devices such as mobile client devices. In some embodiments, authentication information is provided by the user to the client device and/or by the client device to the server in order to establish the user's authorization to receive the security threat information, and/or to use as a basis for selecting the security threat information to be provided to the client device.

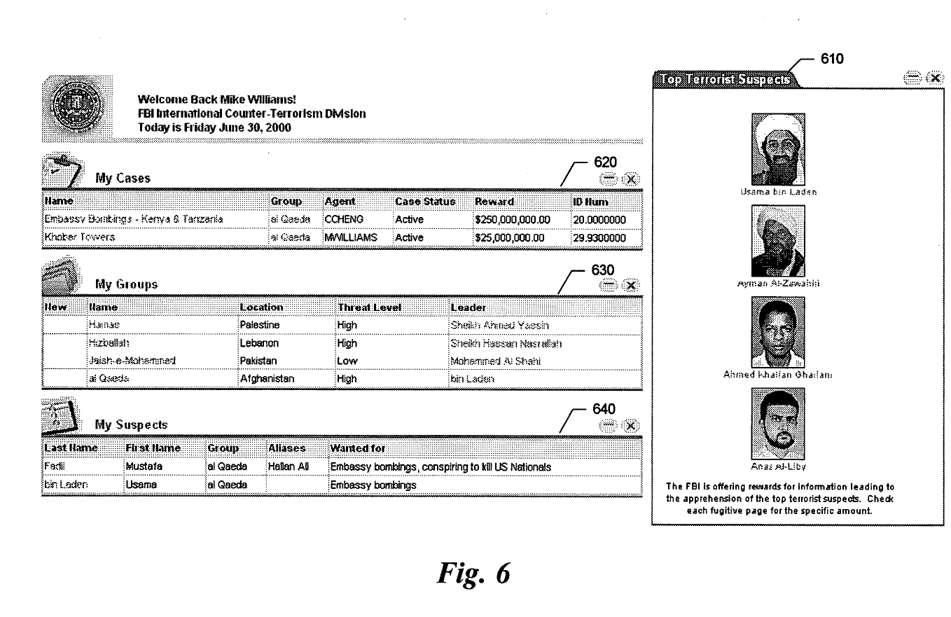

Embodiments of the facility provide different portals for each of a number of different security threat information constituencies. These constituencies, also called “user classes,” “user roles,” or “responsibilities,” can vary greatly depending upon the needs of the organizations adopting the facility. FIGS. 6-10 are display diagrams showing sample portal displays for a sample set of constituencies: Investigative Agents, State Government Call Center Agents, Public Health Professionals, Members of the Public, Members of the Public with Additional Access Privileges, and System Administrators.

FIG. 6 is a display diagram showing a sample portal display for the Investigative Agent sample constituency. The display includes security threat information useful to users in the Investigative Agents constituency, such as investigative agents from the Federal Bureau of Investigation, or of a state or local law enforcement organization, such as the state patrol, county sheriffs office, or city's police force. In the sample display, such information includes information 610 about top terrorist suspects, including their names and photographs; information 620 about investigation cases assigned to the current user, including the name of the case, a terrorist group to whom responsibility for the case has been attributed, a primary agent for the case, a status for the case, a reward amount for the case, and an identifier for the case; information about terrorist groups that the user is involved in investigating, including the group's name, primary location, assessed threat level, and likely leader; information 640 about terrorism suspects that the user is investigating including each suspect's last name, first name, terrorist group, aliases, and terrorist acts. It can be seen in FIG. 6 and the figures that follow that the portals generated by some embodiments of the facility contain information tailored to the particular user accessing the portal, in addition to the constituency to which the particular user belongs. The level of such tailoring provided by the facility is typically a function of the amount of information available about each user. For example, more information is typically available to the facility about individual users in the Investigative Agents constituency than individual users in the Members of the Public constituency.

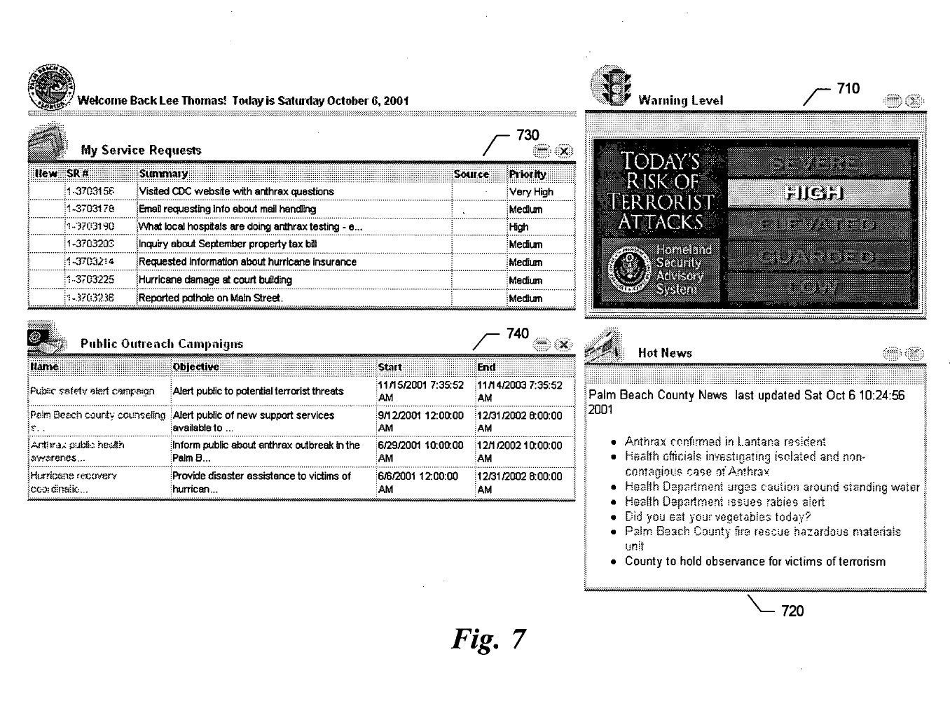

FIG. 7 is a display diagram showing a sample portal display for the State Government Call Center Agent sample constituency. This display includes security threat information useful to users in the State Government Call Center Agent constituency, made up of call center agents making and receiving calls on behalf of a particular state government, such as the government of Florida. In the sample display, such information includes information 710 about the level of current terrorist attack risk; information 720 about breaking news relating to the state; information 730 about service requests being handled by the call center agent, including an indication of whether they are new, a service request identifier, a summary, an indication of the source of the service request, and a priority; and information 740 about public outreach campaigns with which the call center agent is involved, including their name, objective, and start and end dates.

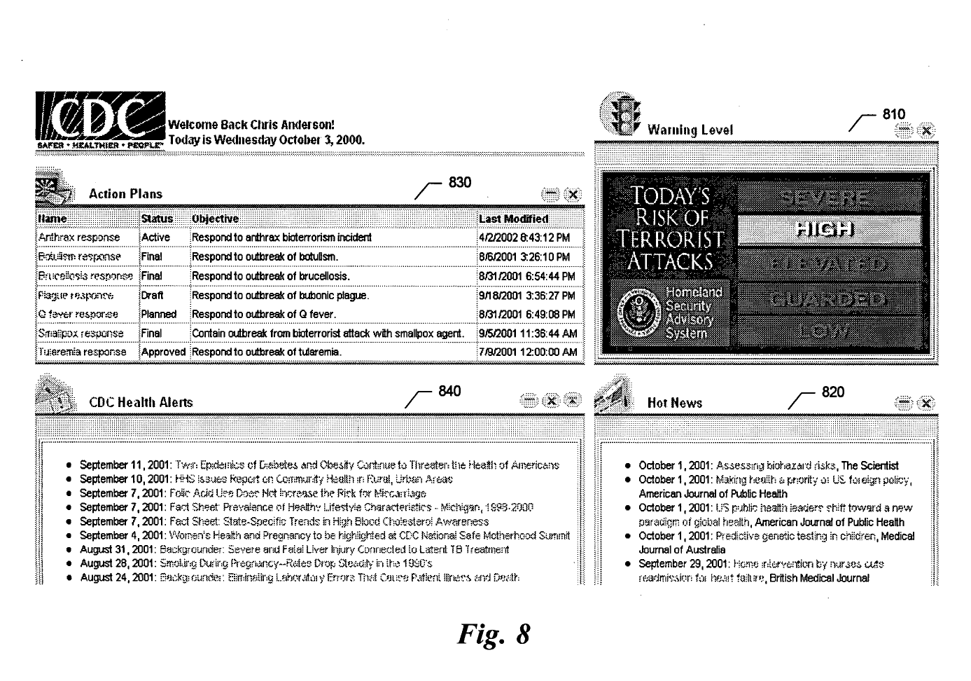

FIG. 8 is a display diagram showing a sample portal display for the Public Health Professional sample constituency. The display includes security threat information useful to users in the Public Health Professional constituency, such as hospital administrators, medical researchers, and employees of the Center for Disease Control. In the sample display, such information includes information 810 about the level of current terrorist attack risk; information 820 about breaking news relating to the state; information 830 about action plans in which the public health professional is involved, including their names, statuses, objective, and date of last modification; and information 840 about current health alerts from the Center for Disease Control. It can be seen in FIG. 8 that certain security threat information, such as information 710 and 810 about the level of current terrorist attack risk, is displayed in the portals for more than one constituency.

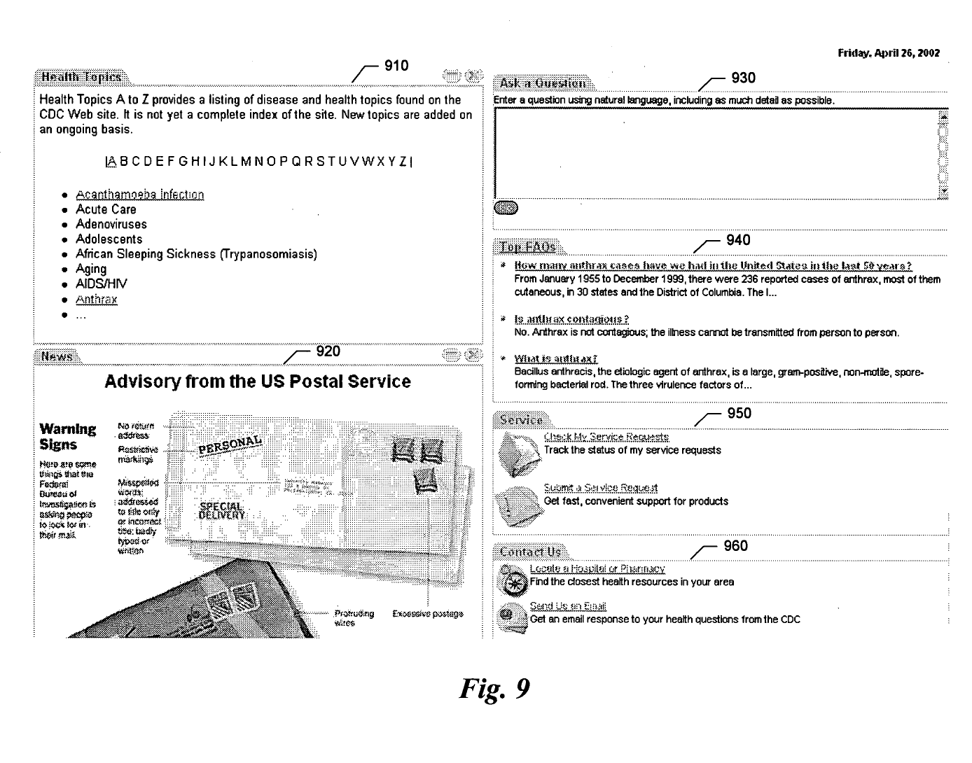

FIG. 9 is a display diagram showing a sample portal display for the Member of Public sample constituency. The display includes security threat information useful to users who are members of the public. In the sample display, such information includes information 910 about various health topics; information 920 about public news, such as an advisory from the U.S. Postal Service about dangerous articles of mail; a field 930 into which the user may enter a question; information 940 about frequently asked questions, including their answers; information 950 about service requests, including tools for submitting service requests and monitoring their status; and information 960 about contacting various agencies that may be helpful to the user.

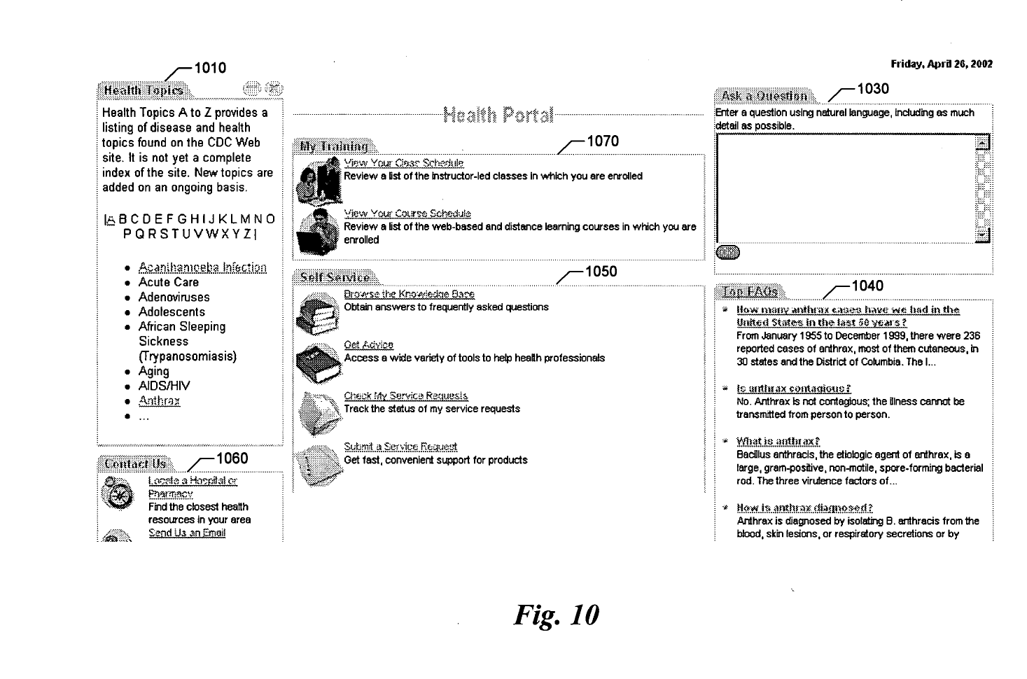

FIG. 10 is a display diagram showing a sample portal display for the Member of Public with Additional Access Privileges sample constituency. The display includes security threat information useful to users in the Member of Public with Additional Access Privileges constituency, such as healthcare workers serving in a medical emergency response corps, etc. In the sample display, such information includes information 1010 about various health topics; a field 1030 into which the user may enter a question; information 1040 about frequently asked questions, including their answers; information 1050 about service requests, including tools for submitting service requests and monitoring their status, as well as additional tools to browse a knowledge base of frequently asked questions and get advice; information 1060 about contacting various agencies that may be helpful to the user; and information 1070 about training for the user in their area of public service. It can be seen that certain security threat information is displayed differently, or with different content, on the portals for different constituencies. For example, information 1050 about service requests is similar to, but contains additional content relative to, information 950 about service requests.

In some embodiments, users in the System Administrators constituency work for one of the other constituencies discussed above, and use the portal provided for that other constituency. For example, system administrators working for the Health Professional constituency (i.e., health professional organizations such as the National Institute of Health) use the portal provided by the facility for the Health Professional constituency. In alternative embodiments, the facility provides a separate portal for members of the System Administrators constituency.

In some embodiments, the information displayed by the facility in the constituency-based portals that it provides is provided from a central data store. In various embodiments, this central data store comprises a single database table; multiple related database tables stored in a single database; information periodically retrieved and/or aggregated from multiple computer systems, including different computer systems owned or operated by various organizations and other entities; and/or a virtual data store that facilitates the retrieval of data from outside sources only when the data is needed for display or processing.

In some embodiments, the facility provides a web-based, off-the-shelf application for use by security-tasked government agencies, providing such services as collecting, analyzing, synthesizing, and distributing security threat information. In some, embodiments, the application is usable by multiple such agencies to communicate and share information, providing a vehicle for quickly moving important information to the appropriate individuals, even if they are in different organizations.

Applications provided by the facility may execute on Enterprise Servers 250 shown in FIG. 2 or similar servers, and may be used by users using clients such as client 205 and 210 shown in FIG. 2 or similar clients.

Additional details of providing such an application are contained in the following patent applications, each of which is hereby incorporated by reference in its entirety: U.S. patent application Ser. No. 09/969,856, entitled “METHOD, APPARATUS, AND SYSTEM FOR IMPLEMENTING A FRAMEWORK TO SUPPORT A WEB-BASED APPLICATION,” filed Sep. 29, 2001; and U.S. patent application Ser. No. 09/967,760, entitled “COMPUTING SYSTEM AND METHOD TO PERFORM RUN-TIME EXTENSION FOR WORLD WIDE WEB APPLICATION,” filed Sep. 28, 2001.

In some embodiments, the facility provides support for the biometric screening of individuals designated as terrorism suspects. Agents having appropriate authorization may use the facility to select certain individuals identified within the facility for particular treatment when they are identified using biometric screening. For example, biometric screening may be performed by a contractor at airport boarding gates. For each of a number of individuals, authorized agents can use the facility to designate particular treatment of the individual to be undertaken when biometric screening at a boarding gate identifies a passenger as the individual. For example, the facility may be used to designate that certain individuals are to be denied boarding, others are to be detained, and still others are to be unobtrusively reported to have boarded. The facility makes these designations available to the biometric screening contractor, who associates them with biometric profiles usable to identify the individuals during biometric screening.

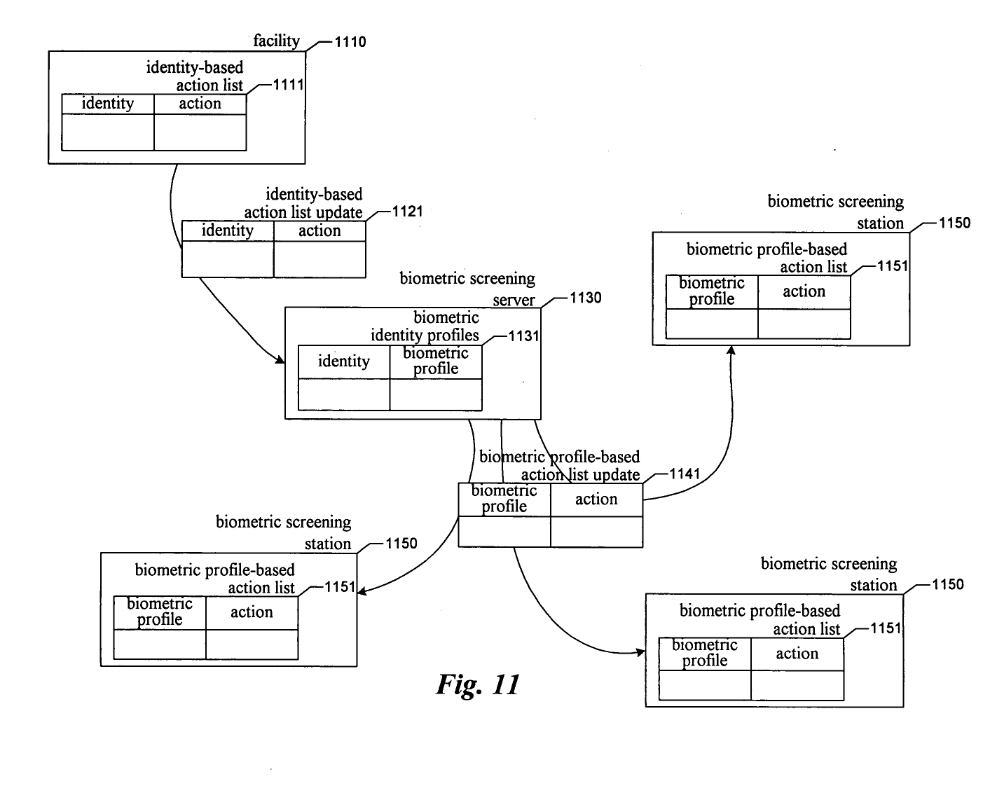

FIG. 11 is a data flow diagram showing a typical process used by the facility to support the biometric screening of individuals designated as terrorism suspects. The facility 1110 compiles an action list 1111 based upon the input of agents authorized to specify actions to be applied to individuals when they are identified at biometric screening stations. The facility periodically sends an update 1121 reflecting any changes to the identity-based action list to a biometric screening server 1130.

The biometric screening server 1130 maintains identity profiles 1131 that indicate, for each of a number of individuals of interest, data comprising a biometric profile of that individual. Each biometric profile contains data that may be used to identify the corresponding individual based upon one or more different kinds of biometric traits, such as retinal structure, fingerprints, voiceprints, gross structural dimension ratios, etc.

Based upon the information received in identity-based action list update 1121, the biometric screening server 1130 uses its identity profiles 1131 to generate a biometric profile-based action list update 1141 in which the action specified in identity-based action list update 1121 is designating for the biometric profile of each individual specified in the identity-based action list update. The biometric screening server 1130 distributes the biometric profile-based action list update 1141 to each of a number of biometric screening stations 1150. These biometric screening stations may be located in a wide variety of locations where there is an opportunity to subject people to biometric screening, such as airports, national borders, places of business, the sites of large gatherings such as sporting events, etc. The biometric screening stations 1150 use the biometric profile-based action list update 1141 to update their biometric profile-based action lists, 1151, which designates for each of a number of biometric profiles the action to be taken if an individual matching that biometric profile is screened at the biometric screening station.

IV. Conclusion

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1. A method in a computing system for disseminating information regarding investigating a terrorism suspect, comprising:
identifying a mobile device used by an addressee of a message containing instructions for investigating a terrorism suspect; and
transmitting the message to the identified mobile device.

2.-7. (canceled)

8. A method in a computing system for disseminating information regarding a terrorism suspect, comprising:
for each of a plurality of users:
receiving information identifying the user;
based on the received information identifying the user, identifying among a plurality of user classes a user class to which the user belongs, wherein the plurality of user classes includes one or more user classes selected from the set of: investigative agents, health professionals, members of the public, and members of the public with additional access privileges; and
displaying to the user instructions for investigating a terrorism suspect, the instructions tailored for users in the identified user class.

9. The method of claim 8 wherein the displayed instructions are generated by applying to a central store of homeland security information one of a plurality of views on the central store, the applied view corresponding to the identified user class.

10. (canceled)

11. The method of claim 8 wherein the instructions are displayed using the world wide web.

12. The method of claim 8 wherein the instructions are displayed in a web browser.

13. The method of claim 8 wherein displaying the instructions includes transmitting the displayed body of instructions over a network.

14. The method of claim 8 wherein displaying the instructions includes transmitting the displayed instructions over a local area network.

15. The method of claim 8 wherein displaying the instructions includes transmitting the displayed instructions over a wide area network.

16. The method of claim 8 wherein displaying the instructions includes transmitting the displayed instructions over the Internet.

17. The method of claim 8 wherein the instructions are subsetted for display based on user identity.

18.-23. (canceled)

24. A method in a computing system for facilitating biometric identification of terrorism suspects, comprising:
receiving indications that each of a plurality of individuals is a terrorism suspect; and
transmitting identifying information for each of the plurality of individuals to a receiver,
such that the receiver of the identifying information may use the received identifying information to retrieve biometric profile information for each of the plurality of individuals using the received identifying information and compare the retrieved biometric profile information to biometric information received from a biometric scanner scanning a scanning subject to determine whether the scanning subject is among the plurality of individuals indicated to be a terrorism suspect.

25. The method of claim 24, further comprising:
for each of the plurality of individuals that are indicated by the received indications to be terrorism suspects, receiving an indication of an action to be performed if the individual is identified; and
transmitting with the transmitted identifying information for each of the plurality of individuals an indication of an action to be performed if the individual is identified that is based on the received indication of an action to be performed if the individual is identified.

26. One or more data signals embodied in a carrier wave conveying a data structure, the data structure comprising identifying information for a plurality of individuals selected as detainee prospects,
such that a receiver of the data structure may use the identifying information to retrieve biometric profile information for each of the plurality of individuals using the received identifying information and compare the retrieved biometric profile information to biometric information received from a biometric scanner scanning a scanning subject to determine whether the scanning subject is among the plurality of individuals selected as detainee prospects.

27. The data signals of claim 26 wherein the data structure further comprises, for one or more of the plurality of individuals for which identifying information is present, instructions for detaining the individuals.

28. A method in a computing system for preventing potential terrorist acts by identifying terrorists, comprising:
identifying a mobile device used by an addressee of a message containing homeland security information that includes (a) identifying information for one or more terrorism suspects, and (b) instructions for directly preventing a potential terrorist act by the identified terrorism suspects; and
transmitting the message to the identified mobile device.

29. (canceled)
